(19) United States
(12) Patent Application Publication
(10) Pub. No.: US 2004/0114222 A1
(43) Pub. Date: Jun. 17, 2004

(54) Information input device

(75) Inventor: Masaya Katsumata, Sagamihara-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: OLYMPUS OPTICAL CO., LTD, TOKYO (JP)

(21) Appl. No.: 10/321,285

(22) Filed: Dec. 17, 2002

(51) Int. Cl. G02B 21/00

(52) U.S. Cl. 359/380

(57) ABSTRACT

An information input device according to the present invention is an information input device having a computer and an external input device, and inputting information to a predetermined device. The external input device comprises one or more operation switches, and a notifying unit discretely notifying the computer from when an operation switch becomes ON state until when the operation switch becomes OFF state. Additionally, the computer comprises a transmitting unit transmitting to the external input device a command(s) to instruct the predetermined device of a process(s) corresponding to the operation switch in correspondence with a notification. With this configuration, the predetermined device can immediately stop an action process even if a communication fault occurs during the action process.

### BACKGROUND OF THE INVENTION

1. Field of the Invention

The present invention relates to an information input device for a predetermined device of an electric microscope, etc.

2. Description of the Related Art

To make respective parts of a microscope device, such as an objective lens(es), a filter(s), a stage, etc. perform an action by a user, it is considered that action functions for the respective parts are defined for a plurality of buttons arranged on the main body of the microscope device, and the user controls the microscope device by manipulating these operation buttons.

Additionally, it is being considered to implement a configuration rich with function expandability not by fixing and assigning a particular function to an operation button, but by assigning an arbitrary function with an arrangement of a computer between an operation button and a microscope, and by setting the function of each operation button in this computer. In the case of this configuration, a method with which firmware detecting that a button is pressed does not determine which function is assigned to the pressed button, determines only the type of the button, and notifies a connected computer, and the computer determines the function of the pressed button, and transmits an action instruction to the firmware as a command(s) is adopted.

Among functions set for operation buttons, there is a function that does not achieve an object unless the same button continues to be pressed, in addition to a function that terminates a target action/operation by pressing an operation button only once. Assume that functions “stage-up” and “stage-down”, which are intended to adjust the height of a microscope stage, are assigned to two certain buttons. Originally, height adjustment must be made without steps. Actually, however, a step size is determined to be, for example, 1 μm, etc. for the sake of convenience. Accordingly, to raise/lower the stage, for example, in a 100 mm range, a button operation by 100,000 steps is required. Or, to lower the stage by 100 μm, an operation by 100 steps, namely, the same button must be pressed 100 times.

To avoid this, an operation method for maintaining the state where a button is being pressed until its target function is achieved once the button is pressed, and for releasing the button upon termination of a process is considered. For example, a user lowers a stage in the state where a button to which “stage-down” is assigned is being pressed, and moves his finger off the button in a position where a focus is properly obtained so as to obtain the focus while viewing an out-of-focus sample image when he looks through a microscope.

To implement such an operation method, in the case of a configuration where button information indicating that a button is pressed is directly input from a control line of hardware to a computer not via the firmware of a control box, a square wave which indicates the state where the same button is being pressed and is shown in FIG. 1 is ANDed with a continuous square wave generated by a crystal oscillator, etc., and an ANDed result is transmitted to the computer which controls the height of a stage, as disclosed by Japanese Patent Publication No. Hei 5-46293.

FIGS. 2A, 2B, and 2C show respective waveforms in this case.

If a signal shown in FIG. 2A from when an operation button is pressed until when the operation button is released is ANDed with a square-wave signal shown in FIG. 2B, which is generated by crystal oscillation, etc., and has a frequency higher than the signal of FIG. 2A, an ANDed result becomes a signal shown in FIG. 2C. This signal shown in FIG. 2C becomes a signal of square waves the number of which is proportional to the time from when the operation button is pressed until when the operation button is released. Therefore, this signal shown in FIG. 2C is transmitted to a computer side, and a process by the number of square waves is performed on the computer side.

As another implementation method, there is a method with which the firmware of a control box notifies a computer of only a rising edge of a signal, which indicates the pressing start of a button, and a falling edge which indicates when the button is released, for the signal shown in FIG. 1. Namely, for the signal shown in FIG. 1, which is generated from when the operation button is pressed until when the operation button is released, the firmware notifies the computer that the button is pressed upon detection of the rising edge of a signal line, and that the button is released upon detection of the falling edge.

FIG. 3 is a flowchart showing the process performed by the firmware when this method is used.

The firmware determines whether or not a rising edge of a signal is detected firstly as step S101, when starting an edge notification process. If the rising edge is detected (“Yes” in step S101), the firmware transmits to the computer the type of an operation button, and button pressing information indicating that the button is pressed (step S104). Next, in step S102, the firmware determines whether or not a falling edge of the signal is detected. If the falling edge is detected (“Yes” in step S102), the firmware transmits to the computer the type of the operation button, and information indicating that the button is released (step S105). Then, the process is returned to step S101. The above described actions are repeated until a termination request is externally received (“Yes” in step S103).

FIG. 4 is a flowchart showing the process performed on the computer side.

Software on the computer side determines whether or not button pressing information is received as step S111. If the button pressing information is not received (“No” in step S111), the software repeats the processes in steps S111 and S112 until completion of a button action process is externally notified, and enters a reception wait state. If the button pressing information is received in step S111 (“Yes” in step S111), the software performs a process for making a microscope execute the function assigned to the button, such as command issuance, etc. once as step S113.

Since the computer side can recognize which button of which external input device is pressed, it transmits an action instruction to the firmware of the microscope according to the interpretation of this button based on information stored in a storage device of the computer. For example, if a function “stage-up” is assigned to this button, the computer issues a command group which means “stage-up” to the firmware.

Next, the computer side determines whether or not information indicating that the button is released is received as step S114. If the information is not received as a result of the determination (“No” in step S114), the computer side returns the process to step S113 after performing a wait process for time adjustment as step S115. Thereafter, the computer side repeats the processes in steps S113 to S115 until the information indicating that the button is released is received. Or, if the information indicating that the button is released is recognized to be received in step S114 (“Yes” in step S114), the computer side exits the process while the button is being pressed, and transfers the process to step S112. In step S112, the computer side determines whether or not completion of the button action process is externally notified. If the completion is notified (“Yes” in step S112), the computer side terminates the process. If the completion is not notified (“No” in step S112), the computer side transfers the process to step S111. Then, the computer side repeats the processes in steps S111 to S115.

With the method, which is indicated as the above described first method, and directly notifies, by hardware, a computer of a signal, which is obtained by ANDing a button pressing signal and a square-wave signal, the firmware of the control box is not interposed for the passing of a signal. Therefore, some intermediate process cannot be performed in mid course.

Additionally, since dedicated hardware and its interface are required to connect the computer and the control box or an external input device, the computer cannot employ a general-purpose interface such as widely and generally used RS-232C, which is the standard interface of IBM PC-AT compatibles, etc. for a communication with the control box, etc.

Furthermore, with the above described second method, a communication technique implemented by software is used. Therefore, a general-purpose interface such as RS-232C, etc. can be used for a communication. However, if a communication path from a control box to a computer is disconnected due to plug-out of a communication cable, etc. by some reason after button pressing information is transmitted to the computer, the information indicating that the button is released cannot be communicated from the control box to the computer. Therefore, the microscope does not stop its action. Namely, the loop in steps S113 to S115 of FIG. 4 is repeated, and the process in step S113, which is performed by pressing the button once, continues permanently. Accordingly, for example, if the stage-up function is assigned to the pressed button, a sample on a slide glass and an objective lens gradually approach as a result of pressing the button, and the stage-up action does not stop even if the hand is moved off from the button in the case where a cable is disconnected while the button is being pressed.

### SUMMARY OF THE INVENTION

The present invention is predicated on an information input device that comprises a computer and an external input device, and inputs information to a predetermined device.

In a device according to a first preferred embodiment of the present invention, the external input device comprises: one or more operation switches; and a notifying unit discretely notifying the computer from when an operation switch becomes ON state until when the operation switch becomes OFF state.

Additionally, the computer comprises a transmitting unit transmitting to the external input device a command to instruct the predetermined device of a process corresponding to the operation switch in correspondence with the notifying.

With this device according to the first preferred embodiment, the predetermined device can stop its action even if a fault occurs from when an operation button becomes ON state, since a command is intermittently issued.

In a device according to a second preferred embodiment of the present invention, the external input device comprises: one or more operation switches; a first notifying unit notifying the computer that an operation switch becomes ON state; a first transmitting unit transmitting button pressing information to the computer upon receipt of an information transmission request from the computer when the operation switch is in the ON state; and a second notifying unit notifying the computer that the operation switch becomes OFF state.

Additionally, the computer comprises: a second transmitting unit discretely transmitting the information transmission request to the external input device from when being notified that the operation switch becomes the ON state until when being notified that the operation switch becomes the OFF state; and a third transmitting unit discretely transmitting to the external input device a command to instruct the predetermined device of a process corresponding to the operation switch, when the pressing information is notified from the external input device from when being notified that the operation switch becomes the ON state until when being notified that the operation switch becomes the OFF state.

With this device according to the second preferred embodiment, the predetermined device can stop its action even if a fault occurs from when an operation button becomes ON state, since a command is intermittently issued. Additionally, a command is transmitted with secure procedures implemented by transmitting/receiving an information transmission request and button pressing information between the computer and the external input device, so that the action of the predetermined device can be stopped even if either of software of the external input device and the external input device runs away.

A device according to a third preferred embodiment of the present invention comprises: one or more operation switches; a notifying unit notifying the computer that an operation switch becomes ON state; an aborting unit performing an abortion process for the predetermined device, for example, a process for stopping the device, or the like if a process continuance request is not received from the computer for a predetermined time period when the operation switch is in the ON state; and a termination processing unit notifying the computer that the operation switch becomes OFF state.

Additionally, the computer comprises: a process instructing unit transmitting to the external input device a command to instruct the predetermined device of a process corresponding to the operation switch when being notified that the operation switch becomes the ON state; and a process continuance request transmitting unit discretely transmitting the process continuance request to the external input device from when being notified that the operation switch becomes the ON state until when being notified that the operation switch becomes the OFF state.

With this device according to the third preferred embodiment, a command is transmitted from the computer only once when being notified that an operation switch becomes ON state in addition to the operativenesses and the effects of the devices according to the above described first and second preferred embodiments. Accordingly, a smoother action of the predetermined device can be implemented.

In a device according to a fourth preferred embodiment of the present invention, the external input device further comprises a termination process storing unit storing a termination process of a process corresponding to an operation switch in addition to the configuration of the device according to the third preferred embodiment. The termination processing unit decides a termination process for the process corresponding to the operation switch by referencing the termination process storing unit, performs the termination process, and notifies the computer that the operation switch becomes OFF state, when the operation switch becomes the OFF state.

In a device according to a fifth preferred embodiment of the present invention, the external input device comprises: one or more operation switches; a notifying unit notifying the computer that an operation switch becomes ON state; an aborting unit performing an abortion process for the predetermined device if a process continuance request is not received from the computer for a predetermined time period when the operation switch is in the ON state; a rewritable termination process storing unit storing a termination process of a process corresponding to the operation switch when the operation switch becomes OFF state; a termination process rewriting unit rewriting the rewritable termination process storing unit based on a change instruction when the change instruction for the termination process is issued from the computer; and a termination process deciding unit deciding a termination process to be performed by referencing the rewritable termination process storing unit when the operation switch becomes the OFF state.

Additionally, the computer comprises: a process instructing unit notifying the external input device of a command to instruct the process corresponding to the operation switch, an instruction for an additional process if the additional process exists in the termination process corresponding to the operation switch when being notified that the operation switch becomes the ON state; and a process continuance request transmitting unit discretely transmitting the process continuance request to the external input device from when being notified that the operation switch becomes the ON state until when being notified that the operation switch becomes the OFF state.

With the devices according to the fourth and the fifth preferred embodiments, a time lag caused by the process between the external input device and the computer, which is performed when an operation switch is released, is eliminated in addition to the operativeness and the effect of the device according to the third preferred embodiment, so that the responsiveness of an operation switch in a termination process can be enhanced.

In a device according to a sixth preferred embodiment of the present invention, the computer further comprises a termination process notifying unit notifying the external input device of a termination process of a process corresponding to an operation switch when being notified that the operation switch becomes ON state in addition to the configuration of the device according to the third preferred embodiment. The termination processing unit performs the termination process, and notifies the computer that the operation switch becomes OFF state, when the operation switch becomes the OFF state.

With the device according to the sixth preferred embodiment, there is no need to comprise a termination process storing unit in addition to the operativeness and the effect of the device according to the fifth preferred embodiment. Accordingly, a limitation imposed by a storage capacity does not occur.

### BRIEF DESCRIPTION OF THE DRAWINGS

FIG. 1 shows a signal when an operation button is pressed and released;

FIGS. 2A, 2B, and 2C show respective signals when a button pressing signal and a square-wave signal are ANDed;

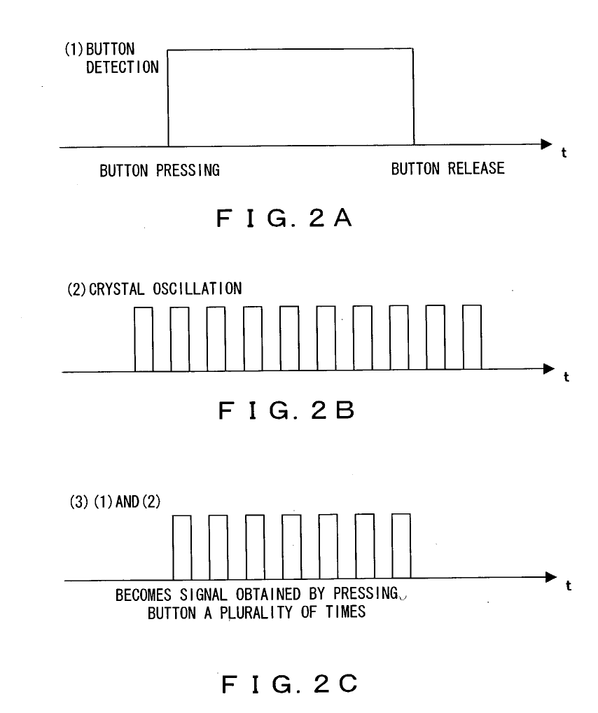

FIG. 3 is a flowchart showing the process performed by firmware of a control box in a conventional microscope;

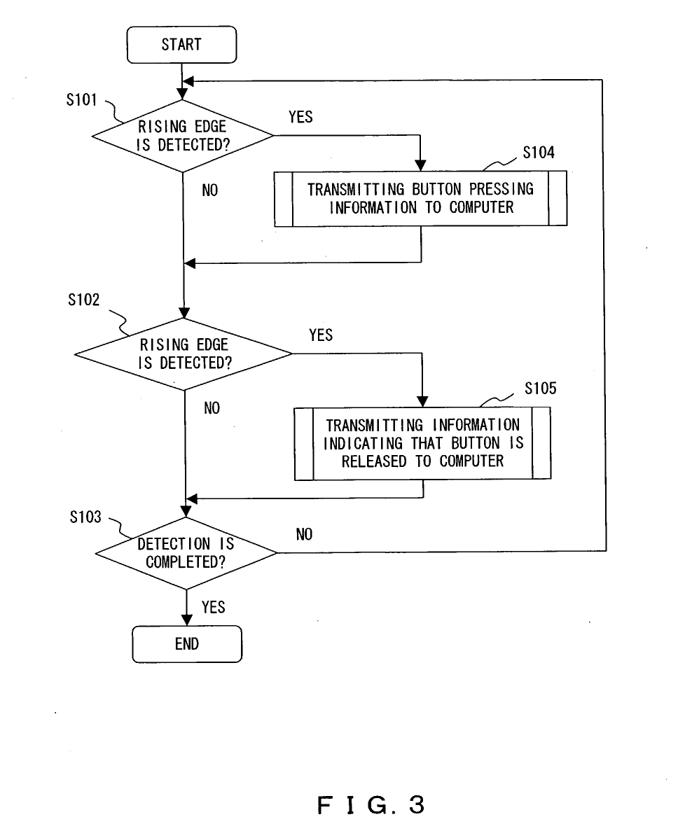

FIG. 4 is a flowchart showing the process performed on a computer side in the conventional microscope;

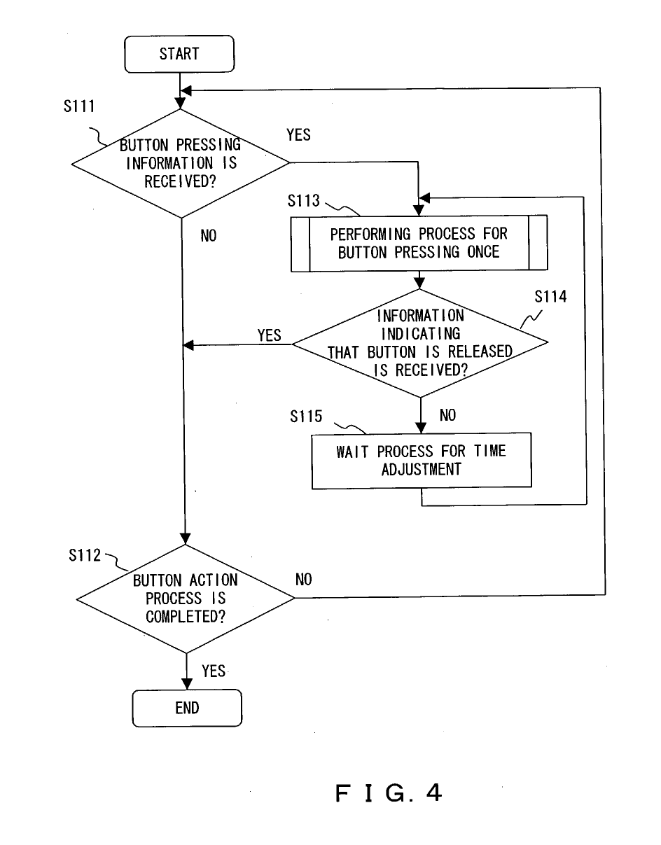

FIG. 5 shows the system configuration of this preferred embodiment;

FIG. 6 shows the relationship between a computer and an external input device in this preferred embodiment;

FIG. 7 is a flowchart showing the process performed by firmware of a control box in a first preferred embodiment;

FIG. 8 is a flowchart showing the process performed on a computer side in the first preferred embodiment;

FIG. 9 is a flowchart showing the process performed by firmware of a control box in a second preferred embodiment;

FIG. 10 is a flowchart showing the process performed by a computer side in the second preferred embodiment;

FIG. 11 is a flowchart showing the process performed by firmware of a control box in a third preferred embodiment;

FIG. 12 is a flowchart showing a detailed example of a process in step S48 of FIG. 11 in the third preferred embodiment;

FIG. 13 is a flowchart showing the process performed on a computer side in the third preferred embodiment;

FIG. 14 is a flowchart showing a detailed example of a process in step S52 of FIG. 13 in the third preferred embodiment;

FIG. 15 exemplifies the configuration of a table indicating a default termination process;

FIG. 16 is a flowchart showing a detailed process in step S48 of FIG. 11 in a fourth preferred embodiment;

FIG. 17 is a flowchart showing a detailed example of a process in step S52 of FIG. 13 in the fourth preferred embodiment; and

FIG. 18 is a flowchart showing a detailed process in step S48 of FIG. 11 in a sixth preferred embodiment.

### DESCRIPTION OF THE PREFERRED EMBODIMENT

Hereinafter, preferred embodiments according to the present invention are explained with reference to the drawings.

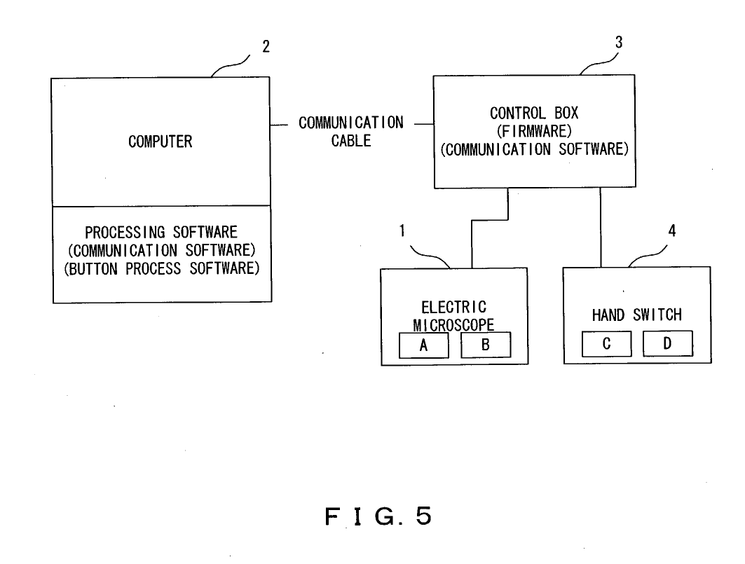

System configuration of the first preferred embodiment is shown in FIG. 5.

The system shown in FIG. 5 is configured by an electric microscope 1, a computer 2, a control box 3, and a hand switch 4. The control box 3 is connected to the computer 2 via an RS-232C cable, and also connected to the electric microscope 1 and the hand switch 4 for assisting an operation via dedicated signal lines. Although the hand switch 4 is directly connected to the control box 3, it may be configured to be connected via the electric microscope 1.

Fundamental actions of the electric microscope 1 are stipulated by software within the computer 2. If a user manipulates an operation button, information indicating that the operation button is manipulated is once transmitted to the computer 2, and the electric microscope 1 performs an action based on a control instruction received from the computer 2 via the RS-232C interface.

The computer 2 comprises processing software such as communication software that performs a communication process with the control box 3, and button process software that interprets a command received from the control box 3, and performs a process. The communication software notifies the button process software of the command received by the RS-232C, and detects that an operation button arranged on the electric microscope 1 or the hand switch 4 is pressed (ON state) or released (OFF state).

A microcomputer is comprised within the control box 3. Firmware of the microcomputer manages the dedicated signal lines between the control box 3 and operation buttons on the electric microscope 1 or the hand switch 4, and monitors the states of the respective operation buttons.

Operations buttons [A] and [B] are placed on the electric microscope 1, and operation buttons [C] and [D] are placed on the hand switch 4. These two buttons correspond to an external input device. If a user presses a button on the electric microscope 1 or the hand switch 4, the firmware of the control box 3, which manages the signal lines, detects that the button is pressed. After performing a suitable process, the firmware transmits the information indicating that the button is pressed to the computer 2 via the RS-232C cable as a serial text command.

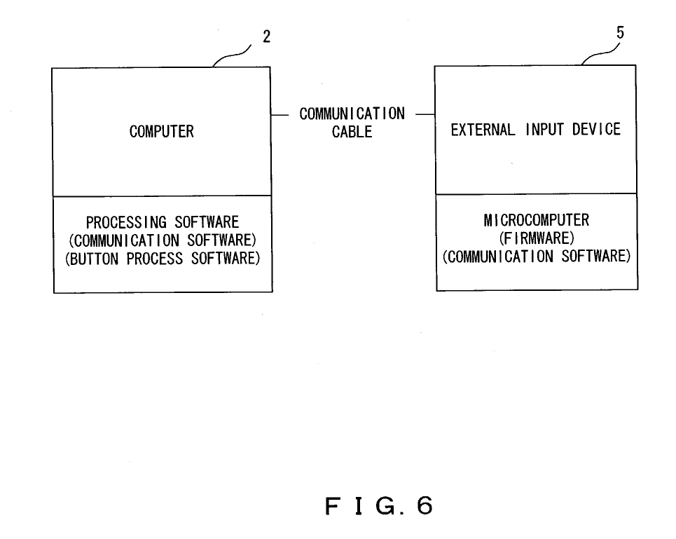

FIG. 6 shows the relationship between the computer 2 and the external input device in this preferred embodiment.

In this preferred embodiment, the operation buttons [A] and [B] arranged on the electric microscope 1, the operation buttons [C] and [D] arranged on the hand switch 4, and the control box 3 which detects the states of these operation buttons correspond to the external input device 5. The external input device 5 and the computer 2 are configured to be connected via a communication cable such as RS-232C, etc. Additionally, the computer 2 and the external input device 5 are seen as an information input device which inputs an action instruction for the microscope device to the microscope device.

In the system shown in FIG. 5, the two operation buttons are respectively configured to be arranged on the electric microscope 1 and the hand switch 4 as the external input device 5. However, the number of operation buttons may be one or three or more, and the number of external input devices 5 may be one or two or more.

Additionally, the control box 3 is configured as a module different from the electric microscope 1 and the hand switch 4 for the sake of convenience. However, these may be integrated into one module, and regarded as the external input device 5. Or, the electric microscope 1 and the control box 3, or the hand switch 4 and the control box 3 may be regarded as one external input device 5.

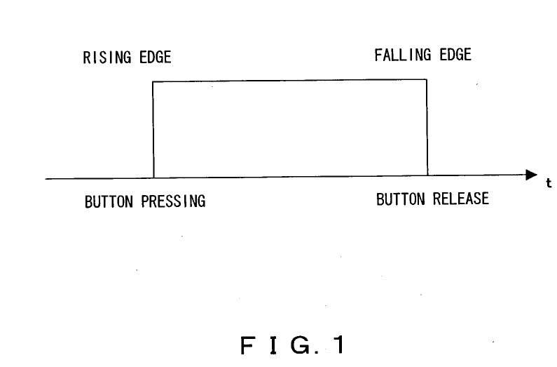

Furthermore, the above described configuration adopts the scheme where the control box 3 and the electric microscope 1 or the hand switch 4 are connected by the dedicated hardware signal lines, and the firmware detects signals like that shown in FIG. 1 on the hardware signal lines. However, the hardware signal lines may be configured to be replaced by general-purpose communication lines such as RS-232C, etc., which can be controlled by software, and the electric microscope 1 may be configured to comprise firmware for control, which makes a communication with the control box 3 as a text command(s).

Next, an action process of the first preferred embodiment is explained.

In the first preferred embodiment, the firmware within the control box 3 monitors the signal lines from the electric microscope 1 and the hand switch 4. And when a rising signal indicating that the button is pressed is detected, the firmware discretely transmits button pressing information indicating that a button is pressed once to the computer 2 at predetermined time intervals until detecting a falling edge indicating that the operation button is released. The computer 2 side performs a corresponding process for receiving the button pressing information from the control box 3.

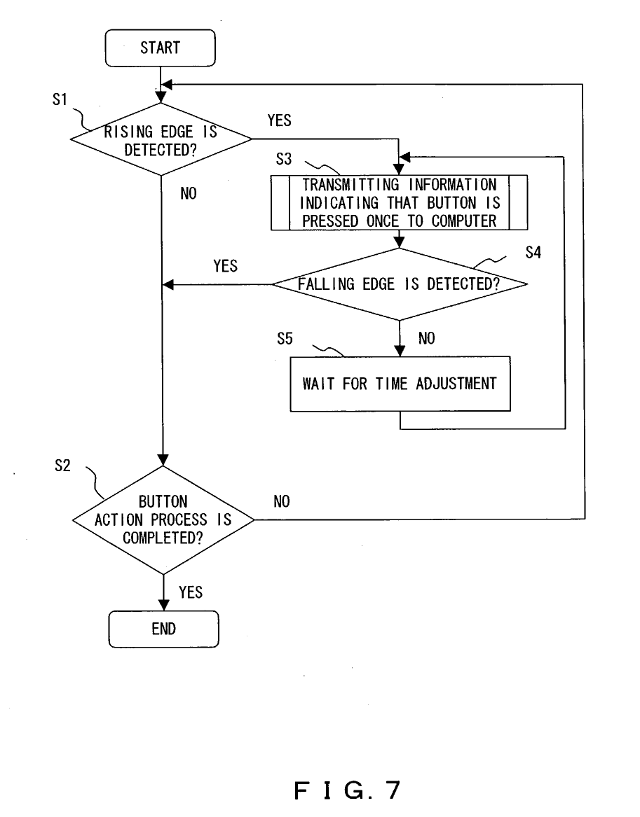

FIG. 7 is a flowchart showing the process performed by the firmware of the control box 3 in the first preferred embodiment.

In the first preferred embodiment, the firmware of the control box 3 monitors the signal lines from the electric microscope 1 and the hand switch 4, and continues to monitor the states of the operation buttons. The firmware monitors the signal lines and performs key scanning until detecting a rising edge on a signal line of an operation button, or until externally receiving a button action process completion notification which notifies the termination of the process, and repeats the loop process in steps S1 and S2 (“No” in step S1, and “No” in step S2).

Upon detection of a rising edge on a certain signal line in step S1 (“Yes” in step S1), the firmware notifies the computer 2 of button pressing information indicating that an operation button is pressed once as an RS-232C command as step S3.

Next, the firmware determines whether or not a falling edge indicating that the button is released as step S4. If the falling edge is not detected as a result of the determination (“No” in step S4), the firmware returns the process to step S3 after performing a wait process for time adjustment as step S5. The firmware repeats the processes in steps S3 to S5 until detecting the falling edge, and continues to transmit the button pressing information to the computer 2. If the falling edge is detected in step S4 (“Yes” in step S4), the firmware exits the process while the button is being pressed, and transfers the process to step S2.

In step S2, the firmware determines whether or not completion of the button action process is externally notified. If the completion is notified (“Yes” in step S2), the firmware terminates the process. If the completion is not notified (“No” in step S2), the firmware transfers the process to step S1. Then, the firmware repeats the processes in steps S1 to S5.

Next, the process performed on the computer 2 side in the first preferred embodiment is explained.

The firmware of the control box 3 performs the action process explained with reference to FIG. 7, and discretely transmits information indicating that “a button is pressed once” to the computer 2 as an RS-232C command while the button is being pressed. Accordingly, the computer 2 side may perform only a process for this information.

For example, if the pressed button is the button [A] on the electric microscope 1, a command indicating that “the button[A] is pressed once” is transmitted from the firmware of the control box 3 as pressing information. The computer 2 that receives this command reads from its own storage area the portion where the function for the button [A] is set, and determines that a “stage-up” function for making a sample on the stage and the objective lens approach by raising the stage is set to the button [A]. Then, the computer 2 issues a “stage-up” command to the firmware of the control box 3, and makes the firmware perform an actual stage action process. If the state where the button is being pressed continues, the command indicating that “the button [A] is pressed once” is transmitted one after another from the firmware. Upon receipt of this command, the processing software of the computer 2 performs a similar process sequentially, and issues a corresponding command to the firmware.

In this way, if a user continues to press the button [A], the stage gradually rises, and stops when a finger is moved off from the button in a suitable position.

In this first preferred embodiment, each time the computer 2 accepts the command indicating that “the button [A] is pressed once”, the “stage-up” command is issued to the control box 3 once, and the electric microscope 1 performs only one stage action. Accordingly, if a disconnection occurs due to some reason such as a plug-out of an RS-232C cable, etc. while the user continues to press the button, the command indicating that “the button [A] is pressed once” is not transmitted from the firmware. Therefore, the action stops, and the stage does not continue to rise.

Additionally, since the control box 3 and the computer 2 are connected with a general-purpose interface such as RS-232C, etc., a special hardware interface is not required. Accordingly, a general-purpose personal computer such as IBM PC-AT compatibles, etc. is available as the computer 2. Furthermore, the information indicating that the button A is pressed is not directly input from the external input device to the computer 2, but transferred via the firmware. Therefore, by way of example, the same time the button [A] is pressed, an additional function such as a function for displaying the button with high brightness, a function for making a beep, a function for making the button undetected depending on a condition, etc. can be implemented by causing the firmware to perform an indirect process.

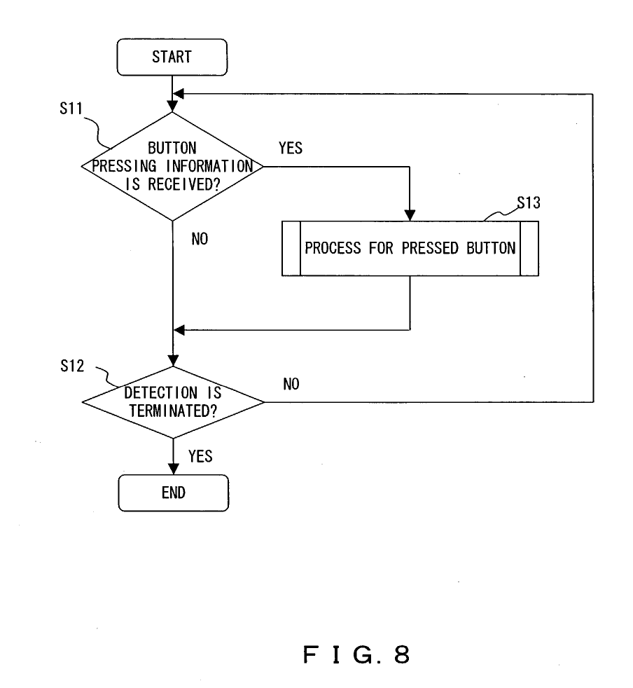

FIG. 8 is a flowchart showing the process performed on the computer side 2 in the first preferred embodiment.

The computer 2 determines whether or not button pressing information is received as step S11. If the button pressing information is received (“Yes” in step S11), the computer 2 transfers the process to step S12 after obtaining the function assigned to the button by referencing its own storage area, and issues and transmits a command(s) having a corresponding function to the firmware of the control box 3 as step S13. The control box 3 transmits this command to the electric microscope 1 unchanged or by converting it into another command, and operates and controls the electric microscope 1.

Or, if the button pressing information is not received in step S11 (“No” in step S11), the computer 2 transfers the process to step S12. Thereafter, the computer 2 repeats the processes in steps S11 and S12 until completion of the button action process is externally notified, and enters a reception wait state. When the completion of the button action process is externally notified (“Yes” in step S12), the computer 2 terminates the process.

Next, the second preferred embodiment according to the present invention is explained. The drawing of system configuration of the second preferred embodiment and its outline are similar to those of the first preferred embodiment shown in FIG. 5.

In the first preferred embodiment, upon detection of a rising edge, the external input device autonomously and discretely transmits button pressing information until a falling edge is detected, and notifies the computer 2 via a communication. When a user releases the button, the button pressing information is not transmitted any more, so that the release of the button is notified to the computer 2.

In the meantime, in the second preferred embodiment, the external input device does not comprise the function for discretely notifying the computer 2, and also the computer 2 side makes a transmission to manage whether or not a button is pressed.

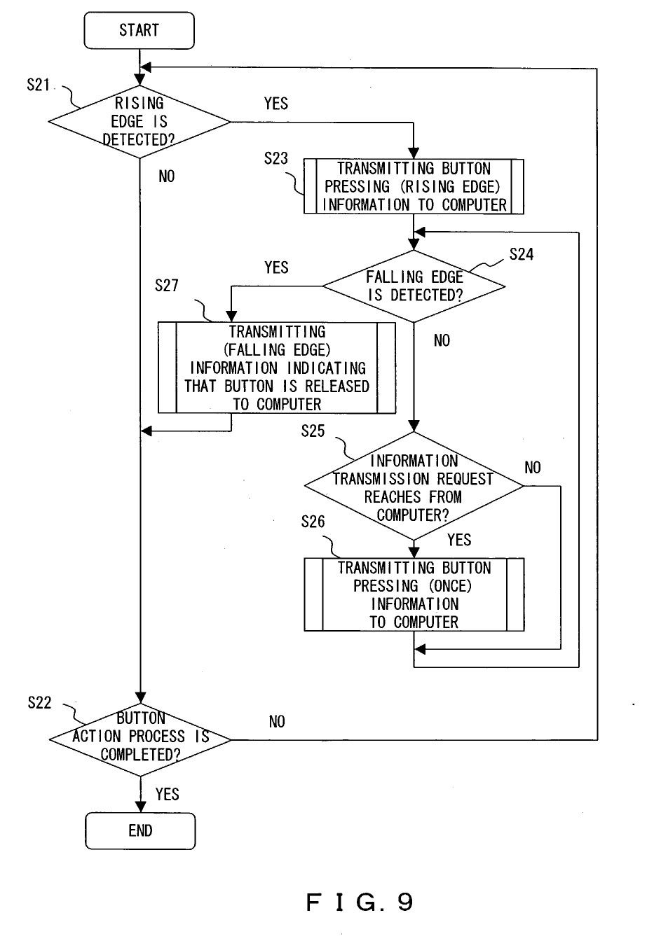

FIG. 9 is a flowchart showing the process performed by the firmware of the control box 3 in the second preferred embodiment.

A difference between the actions of the firmware in the first and the second preferred embodiments exists in a point that the firmware autonomously transmits button pressing information to the computer 2 in the first preferred embodiment, whereas the firmware transmits button pressing information to the computer 2 after receiving an information transmission request from the computer 2 in the second preferred embodiment.

The firmware of the control box 3 monitors the signal lines from the electric microscope 1 and the hand switch 4, and monitors the signal lines and performs key scanning until detecting a rising edge on a signal line of an operation button, or until externally receiving a button action process completion notification which notifies the termination of the process, and repeats the loop process in steps S21 and S22 (“No” in steps S21, and “No” in step S22).

Upon detection of the rising edge on a signal line of a certain key in step S21 (“Yes” in step S21), the firmware notifies the computer 2 of button pressing (rising edge) information indicating that the rising edge is detected as an RS-232C command as step S23.

Next, the firmware determines whether or not a falling edge indicating that the button is released is detected as step S24. If the falling edge is not detected as a result of the determination (“No” in step S24), the firmware next determines whether or not an information transmission request reaches from the computer 2 as step S25. If the request reaches as a result of the determination (“Yes” in step S25), the firmware returns the process to step S24 after transmitting button pressing (once) information to the computer 2 as step S26. If the request does not reach (“No” in step S25), the firmware returns the process to step S24 unchanged, and repeats the processes in steps S24 to S26 until detecting the falling edge. If the falling edge is detected in step S24 (“Yes” in step S24), the firmware exits the process while the button is being pressed after transmitting (falling edge) information indicating that the button is released to the computer 2 as step S27, and transfers the process to step S22.

In step S22, the firmware determines whether or not completion of the button action process is externally notified. If the completion is notified (“Yes” in step S22), the firmware terminates the process. If the completion is not notified (“No” in step S22), the firmware transfers the process to step S21. Then, the firmware repeats the processes in steps S21 to S26.

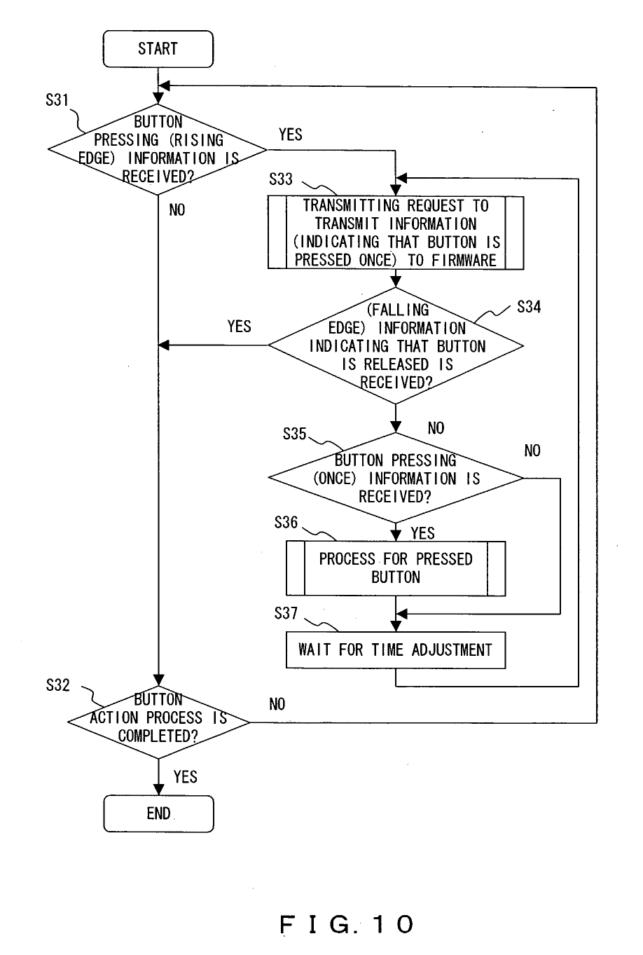

FIG. 10 is a flowchart showing the process performed on the computer 2 side in the second preferred embodiment.

In the second preferred embodiment, upon receipt of button pressing (falling edge) information, the computer 2 enters a process loop while the button is being pressed. Then, the computer 2 transmits a request to transmit information (indicating that the button is pressed once) to the firmware, and performs a process for the pressed button only when button pressing (once) information is received from the firmware as a reply.

The computer 2 determines whether or not the button pressing information (rising edge) is received as step S31. If the computer 2 does not receive the information (“No” in step S31), it repeats the processes in steps S31 and S32 until completion of the button action process is externally notified, and enters a reception wait state.

If the computer 2 receives the button pressing information (rising edge) (“Yes” in step S31), it obtains the function assigned to the button by referencing its own storage area, and issues and transmits a command(s) having a corresponding function to the firmware of the control box 3 as step S33. Next, the computer 2 determines whether or not (falling) information indicating that the button is released. If the information is received as a result of the determination (“Yes” in step S34), the computer 2 exits the process while the button is being pressed, and transfers the process to step S32.

If the (falling) information indicating that the button is released is not received in step S34 (“No”in step S34), the computer 2 next determines whether or not button pressing (once) information is received as step S35. If the information is received, the computer 2 obtains the function assigned to the button by referencing its own storage area, and transfers the process to step S37 after issuing and transmitting a command(s) having a corresponding function to the firmware of the control box 3 as step S36. Or, if the button pressing (once) information is not received in step S35, the process is transferred to step S37 unchanged. The control box 3 transmits this command(s) to the electric microscope 1 unchanged, or by converting it into another command(s), and operates and controls the electric microscope 1.

In step S37, after performing a wait process for time adjustment, the computer 2 transfers the process to step S33. Thereafter, the computer 2 repeats the processes in steps S33 to S37 as a process while the button is being pressed until (falling edge) information indicating that the button is released is determined to be received in step S34.

If the (falling edge) information indicating that the button is released is determined to be received in step S34 (“Yes” in step S34), the computer 2 transfers the process to step S32. Thereafter, the computer 2 repeats the processes in steps S31 to S37 until completion of the button action process is externally notified, and terminates the process when the completion of the button action process is externally notified (“Yes” in step S32).

As described above, also in the second preferred embodiment, an effect similar to that cited in the first preferred embodiment can be obtained. Additionally, the firmware of the control box 3 and the computer 2 securely make a communication according to procedures. Therefore, a continuous transmission of button pressing information can be stopped not only when hardware is disconnected, but also when either of software runs away.

Next, the third preferred embodiment is explained. The drawing of system configuration of the third preferred embodiment and its outline are the same as those of the first preferred embodiment shown in FIG. 5.

In the first preferred embodiment, button pressing information (rising edge) is used, and the external input device autonomously and discretely notifies the computer 2 of the button pressing information. When a user releases a button (falling edge), information notification to the computer 2 is stopped.

Assume that brightness-up and brightness-down functions are assigned to two buttons when the brightness of a sample is changed. If a user desires to increase the brightness step by step, the user continues to press the button to which the corresponding function is assigned, so that a plurality of commands to increase the brightness are issued consequently. Since the user can visually verify that the brightness is increasing step by step, there is no problem.

However, if a function which includes not only an electric action, but also. a mechanical action such as raising the stage is executed, the following problem occurs.

Because an electric signal increases the brightness of a lamp, a command is always executed if it is sequentially issued. Therefore, a response is quick. However, since up-and-down movements of the stage are mechanically made with a motor, etc., and acceleration, moving speed, and deceleration must be given to a target (stage) to be moved so as to move to a target position, a time is required from the stopped state to the beginning of an action.

Accordingly, a response becomes slow if a stage-up command is issued intermittently. This is similar also in the case where the process is implemented according to the second preferred embodiment. The third preferred embodiment addresses this point, and continues an action with one command.

A significant difference between the process flow of the third preferred embodiment and those of the first and the second preferred embodiments exists in a point that a process for a pressed button is performed only once.

In the first and the second preferred embodiments, the control box 3 transmits button pressing information to the computer 2 many times with the loop process while a button is being pressed, and the computer 2 transmits the command for the process corresponding to the pressed operation button to the control box 3. Accordingly, the processes such as button-up, stage-up, etc. are performed in small steps for each loop.

In the meantime, in the third preferred embodiment, an instruction command is issued at the start only once, and only a transmission of a process continuance request is made thereafter. Accordingly, if the stage is desired to be raised, a process for moving the stage to the upper limit of the stage movement is instructed only once. Then, in a subsequent loop process, only the continuance request is issued, and a command to instruct the movement of the stage is not newly issued. Furthermore, the firmware side only detects a continuance request and a falling edge, and performs nothing. The firmware side does not perform an abortion process or a stage stop process for the stage until reception of the continuance request is stopped.

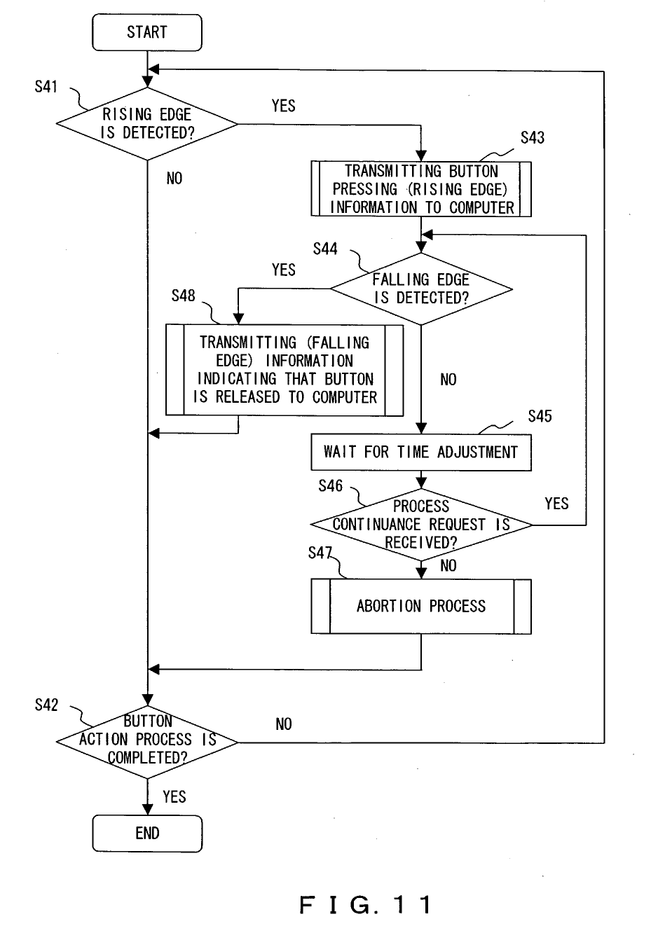

FIG. 11 is a flowchart showing the process performed by the firmware of the control box 3 in the third preferred embodiment.

In the third preferred embodiment, after the firmware of the control box 3 notifies the computer 2 that a rising edge is detected, it continues a process if a process continuance request is received from the computer 2 for a particular time period, or performs an abortion process to exit a loop process if the process continuance request is not received.

The firmware of the control box 3 monitors the signal lines from the electric microscope 1 and the hand switch 4. The firmware monitors the signal lines and performs key scanning until detecting a rising edge on a signal line of an operation button, or until externally receiving a button action process completion notification which notifies the termination of the process, and repeats the loop process in steps S41 and S42 (“No” in step S41, and “No” in step S42).

Upon detection of the rising edge on a signal line of a certain key in step S41 (“Yes” in step S41), the firmware notifies the computer 2 of button pressing (rising edge) information indicating that the rising edge is detected as an RS-232C command. Then, the firmware receives a device control command issued from the computer 3 side in correspondence with this notification, and controls a device according to this command.

Next, the firmware determines whether or not a falling edge indicating that the button is released is detected as step S44. If the falling edge is not detected as a result of the determination (“No” in step S44), the firmware determines whether or not a process continuance request is received from the computer 2 as step S46 after performing a wait process for time adjustment as step S45. If the process continuance request is received as a result of the determination (“Yes” in step S46), the firmware returns the process to step S44. Thereafter, the firmware repeats the processes in steps S44 to S46 until the falling edge is detected, or until the reception of the process continuance request from the computer 2 is stopped. Or, if the process continuance request is recognized not to be received from the computer 2 in step S46 (“No” in step S46), the firmware determines that some factor to abort the process, such as a disconnection, a communication fault, software runaway, etc. occurs, and transfers the process to step S42 after performing an abortion process such as stopping the action of the electric microscope 1, etc. as step S47.

Or, if the falling edge is determined to be detected in step S44 (“Yes” in step S44), the firmware exits the process while the button is being pressed, and transfers the process to step S42 after transmitting the (falling edge) information indicating that the button is released to the computer 2 as step S48.

In step S42, the firmware determines whether or not completion of the button action process is externally notified. If the completion is notified (“Yes” in step S42), the firmware terminates the process. If the completion is not notified (“No” in step S42), the firmware transfers the process to step S41. Then, the firmware repeats the processes in steps S41 to S48.

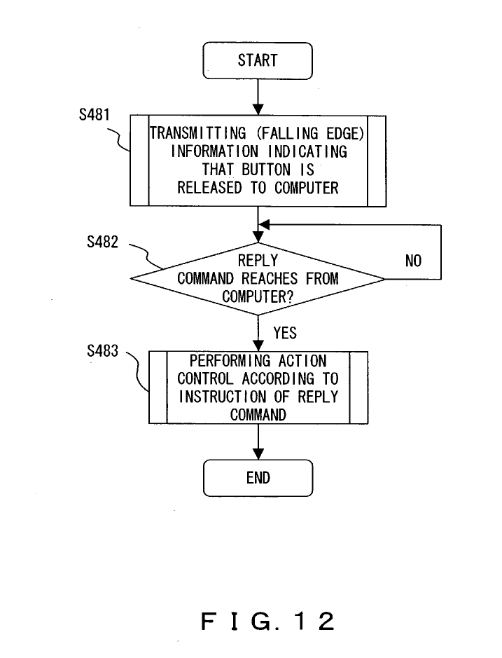

FIG. 12 is a flowchart showing a detailed example of the process in step S48 of FIG. 11.

In the process shown in this figure, (falling edge) information indicating that a button is released is first transmitted to the computer 2 as step S481. Next, a reply to the notification in step S481 from the computer 2 is waited (“No” in step S482). If the reply is returned (“Yes” in step S482), this process is terminated after an action process according to this reply process is performed as step S483.

In the process example shown in this figure, the reply to the notification indicating that the button is released is received from the computer 2. However, depending on an action function set for the button, the action process may be autonomously completed in a similar manner as in the case where the reception of a process continuance request is stopped after information indicating that a button is released is transmitted to the computer 2.

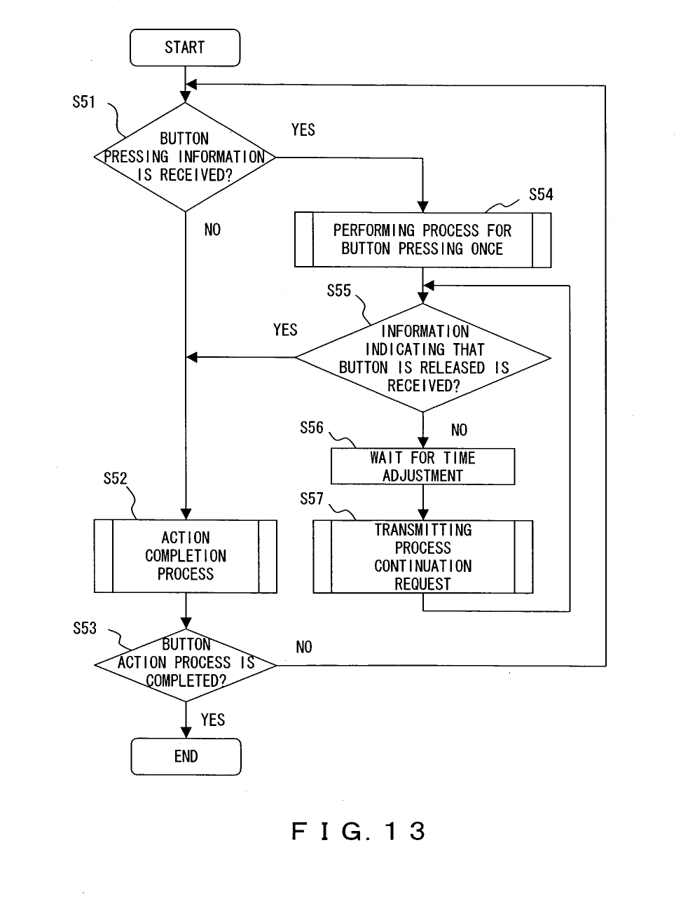

FIG. 13 is a flowchart showing the process performed on the computer 2 side in the third preferred embodiment.

The computer 2 determines whether or not button pressing information is received as step S51. If the button pressing information is not received (“No” in step S51), the computer 2 repeats the processes in steps S51 and S52 until completion of a button action process is externally notified, and enters a reception wait state.

If the button pressing information is received in step S51 (“Yes” in step S51), the computer 2 performs a process for making the microscope execute the function assigned to that button, such as command issuance, etc. once as step S54. The control box 3 transmits to the electric microscope 1 this command unchanged or by converting it into another command(s), and operates and controls the electric microscope 1.

Next, the computer side determines whether or not information indicating that the button is released is received as step S55. If the information is not received as a result of the determination (“No” in step S55), the computer 2 transmits a process continuance request to the firmware of the control box 3 as step S57 after performing a wait process for time adjustment as step S56, and returns the process to step S55.

Thereafter, the computer 2 repeats the processes in steps S55 to S57 until the (falling edge) information indicating that the button is released is received. Or, if the (falling edge) information indicating that the button is released is recognized to be received in step S55 (“Yes” in step S55), the computer 2 exits the process while the button is being pressed, and transfers the process to step S52. After performing an action completion process in step S52, the computer 2 determines whether or not completion of the button action process is externally notified as step S53. If the completion is notified (“Yes” in step S53), the computer 2 terminates the process. If the completion is not notified (“No,” in step S53), the computer 2 transfers the process to step S51, and repeats the processes in steps S51 to S57.

This process is described by taking as an example the case where the button [A] of FIG. 6, for which stage-up is set, is manipulated. If the button [A] is pressed, the computer side receives pressing information of the button [A] from the firmware. In step S54, “stage-up” is interpreted as a process for this button [A], and a “stage-up” command is transmitted to the firmware. Thereafter, the process is transferred to the process loop in steps S55 to S57. During this time, the stage continues to be rising. Here, if information indicating that the button [A] is released is received from the firmware of the control box, the process is transferred to step S52, in which a stage action stop command is transmitted to the firmware.

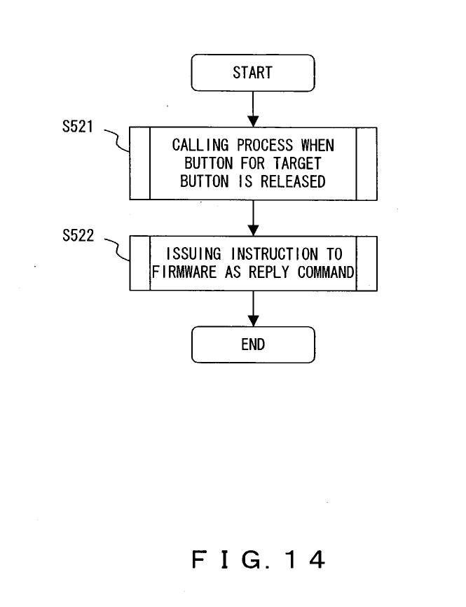

FIG. 14 is a flowchart showing a detailed example of the process in step S52 of FIG. 13.

In this figure, after a process when a target button is released is called from a memory as step S521, and an instruction of a corresponding termination process is issued to the firmware of the control box 3 as a reply command(s) as step S522, this process is terminated.

Note that this process example of FIG. 14 makes a correspondence with that of FIG. 12. For example, if the control box 3 side does not need a reply, the reply is not made to the control box 3 in correspondence with the (falling edge) information indicating that the button is released in step S52.

In this preferred embodiment, for example, the stage-up function is assigned to the button [A] of FIG. 6. If this [A] button is released, the computer 2 calls from the memory the process performed when the button [A] is released, and notifies the firmware of the control box 3 of a corresponding command(s), for example, a command to stop the stage. The firmware performs a corresponding process.

As described above, in the third preferred embodiment, effects similar to those cited in the first and the second preferred embodiments can be obtained, and the issuance of a command to make a function assigned to a button perform an action is only the first one time even if the state where the button is being pressed is continued. Therefore, an action can be performed with a quick response even if a function to be executed includes a mechanical action such as the above described up-and-down movements of the stage, etc.

Next, the fourth preferred embodiment is explained. The drawing of system configuration of the fourth preferred embodiment and its outline are the same as those in the first preferred embodiment shown in FIG. 5.

In the third preferred embodiment, upon detection that a button is pressed, the firmware of the control box 3 notifies the computer 2 side that the button is pressed, and the computer 2 transmits a process continuance request in correspondence with this notification. When the action is started, the firmware periodically notifies the computer 2 side of state information such as continuance, etc. of the action depending on need.

Furthermore, in the third preferred embodiment, if a user releases a button while an action is continued, the firmware detects “(falling edge) information indicating that the button is released”, and notifies the computer 2. Upon detection of the information, the computer 2 transmits an instruction for an action termination process to the firmware as a button action termination process. Namely, after the user releases the button, the termination process is performed with the following procedures.

1) The firmware notifies the computer 2 of the “(falling edge) information indicating that the button is released”.

2) The computer 2 receives that information, and determines a process to be performed as a termination process.

3) The process is transmitted to the firmware as a command(s).

4) The firmware receives the information.

5) The firmware controls the termination of the action.

A user who controls a device such as a microscope, etc. via a button operation desires that the device terminates a process with as quick response as possible when releasing the button.

For example, the case where a stage is moved by pressing a button in a microscope, and stopped in a target position by releasing the button is considered.

Normally, a user moves the stage with an action of “pressing a button” while verifying a sample with his eyes or watching a monitor, and desires to stop the action of the stage by performing an act of “releasing the button” the moment that a position desired to be viewed becomes sharp.

However, since the third preferred embodiment requires the above described steps 1) to 5), an overhead occurs in a communication process or the switching of an operating system (basic software) on the computer 2 side. A time spent by the overhead stays within an expected range in many cases. However, the time is sometimes spent more than expected. Additionally, this overhead hinders a user request regardless of how an expectation is, and how much time is spent. The overhead makes it difficult that a user manipulates a button to issue, for example, a request to immediately stop an action of the stage in a target position, a request to fix the brightness of a lamp, or a request to fix the amount of an AS aperture.

The fourth preferred embodiment, and the fifth and the sixth preferred embodiments, which will be described later, address this point. They omit the above described steps 1) to 4), eliminate the overhead caused by a communication, switching by an operating system, or the like, and improve the operability. Furthermore, even if the computer 2 side that performs a process with a button runs away, the process is immediately stopped when a user releases the button.

In this fourth preferred embodiment, the control box 3 comprises a table indicating a default termination process that is performed when a button for each command is released.

This table is configured in a memory such as a RAM/ROM, etc. within the control box 3. Even if it is configured as a table in its literal sense, or configured as part of a program, there are no problems as far as the table can be referenced.

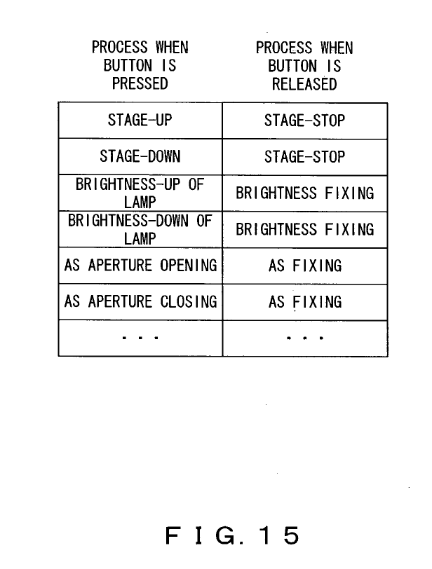

A configuration example of this table indicating a default termination process is shown in FIG. 15. The example of FIG. 15 stipulates the processes performed when a button is released while an action of stage-up/-down, the brightness-up/-down of a lamp, or an AS aperture is being performed.

In the fourth preferred embodiment, upon detection that a button is released, a corresponding termination process is performed by referencing this table by a process currently being performed. For example, a stage-stop process, which includes a backlash correction, is performed if stage-up/stage-down is being performed, or a process for fixing brightness at the time point when a button is released is performed if the brightness-up/-down of a lamp is being performed.

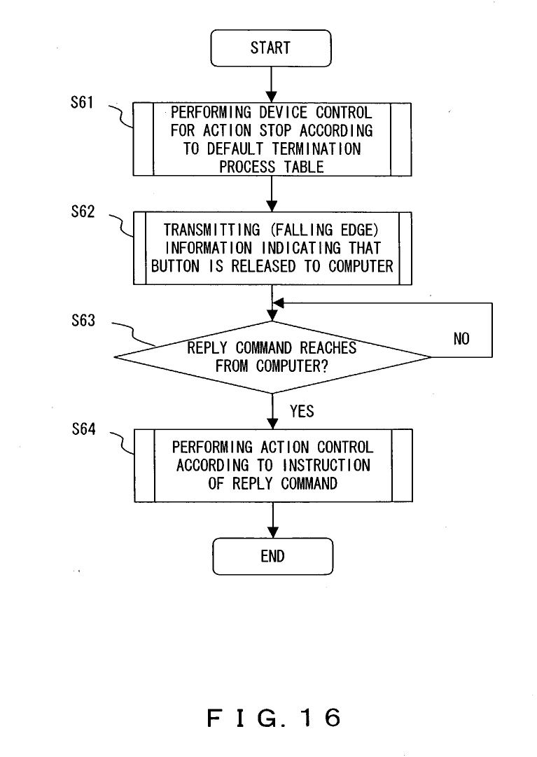

FIG. 16 is a flowchart showing the process performed on the control box 3 side in the fourth preferred embodiment, and corresponds to a detailed process in step S48 of FIG. 11. A fundamental action process in the fourth preferred embodiment is basically the same as that of the third preferred embodiment shown in FIGS. 11 and 13, and only processes in steps S48 and S52 are different.

In the process shown in this figure, upon detection of information (falling edge) that a button is released, the firmware of the control box 3 first examines a process to be performed by referencing the table which indicates a default termination process and is shown in FIG. 15, and performs actual control for a device which is performing an action.

Next, the firmware notifies the computer 2 of the information indicating that the button is released as step S62. Then, the firmware waits for a reply from the computer 2 side (“No” in step S63). When a reply command reaches as a reply (“Yes” in step S63), the firmware performs action control according to this reply command (step S64), and terminates the process. The process is terminated after a corresponding process is performed, for example, if an instruction to perform an additional termination process exists in the reply command, or the process is terminated unchanged if no instruction exists.

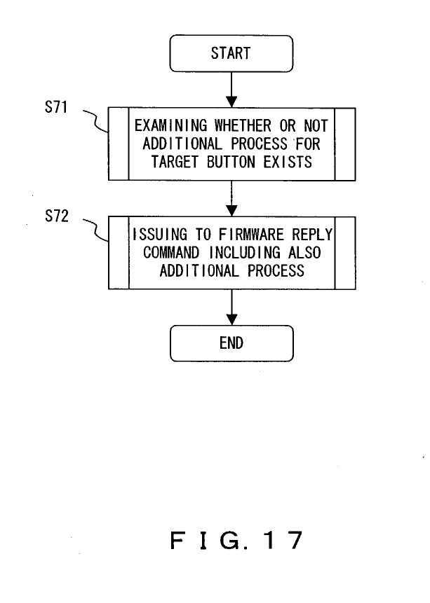

FIG. 17 is a flowchart showing the details of the process in step S52 on the computer side in the fourth preferred embodiment.

Upon receipt of information indicating that a button is released from the control box 3 side, the computer 2 side examines whether or not an additional termination process exists in addition to a termination process set by default in the table on the control box 3 side for the button targeted by the information as step S71, and issues a reply command to the firmware of the control box 3 as step S72. At this time, if the additional process exists in step S71, information instructing that process is added to the reply command. If the additional process does not exist, nothing is added and the reply command is issued.

For example, upon detection that the button [A] to which the stage-up function is assigned is released from the state where it is pressed, the firmware of the control box 3 can know that the stage is to be stopped as a default process for the stage-up by referencing a table like that shown in FIG. 15. Accordingly, the firmware immediately stops the stage, and transmits information indicating that the button [A] is released to the computer 2. Upon receipt of the information, the computer 2 examines whether or not an additional termination process is set for the button [A]. If the additional process exists, the computer 2 indicates that process, and terminates the process. Since the stage-up process does not require an additional process, a reply command is returned, and the process is terminated here. Upon receipt of this reply command, the control box 3 side terminates the process unchanged without performing an additional process.

Next, the fifth preferred embodiment according to the present invention is explained.

Configuration of the fifth preferred embodiment and its fundamental actions are similar to those in the fourth preferred embodiment.

In the fourth preferred embodiment, the table indicating a default termination process, which is comprised by the control box 3 and exemplified in FIG. 15, has fixed values. In the fifth preferred embodiment, a termination process is provided with flexibility by enabling this table to be dynamically rewritten.

Timing when this table is rewritten is arbitrary. It may be timing when a predetermined device such as a microscope device, etc. is started up, timing when certain action mode is switched, timing when a user request is issued, etc. The following explanation is provided by taking as an example the case where the table is changed with each pressing of a button according to a state change during an action.

Most of the actions in the fifth preferred embodiment are the same as those in the fourth preferred embodiment. Therefore, the following explanation refers to a portion where the fifth preferred embodiment performs actions different from those in the other preferred embodiments, with reference to FIGS. 11, 12, and 13.

In the fifth preferred embodiment, in a similar manner as in the above described preferred embodiments, upon detection that a button is pressed in step S41 of FIG. 11, the firmware transmits button pressing information to the computer in step S43. Upon receipt of the information in step S51 of FIG. 13, the computer 2 transmits a control command(s) for that button to the firmware in step S54. In the fifth preferred embodiment, a table change request is transmitted to the control box 3 along with this control command(s) at this time.

Assume that the stage-up is assigned to the button [A], and the default termination process set in FIG. 15 is only “stage-stop”. At this time, the case where a user desires to know the coordinates of the stopped stage when stopping the stage is considered.

In that case, the computer 2 issues a “stage-up” command in step S54 of FIG. 13, and simultaneously issues a command to rewrite the table of FIG. 15 so as to add “stage position information read” to the “stage stop” termination process as an action performed when the stage-up button becomes OFF state. The firmware of the control box 3, which receives this command, rewrites the contents in the position corresponding to the stage-up process in the table shown in FIG. 15. When the user releases the button [A], the firmware of the control box 3 references the rewritten table, and performs not only the “stage stop” but also the “stage position information read”.

As described above, in the fourth and the fifth preferred embodiments, upon detection that a button is released, a termination process to be performed can be decided by referencing the table before the above described procedures 1) to 4) of the electric microscope are taken. Furthermore, in the fifth preferred embodiment, the table can be dynamically changed in mid course. Therefore, the fifth preferred embodiment can address also the case where a termination process is changed in mid course by changing a default setting of the termination process.

Next, the sixth preferred embodiment according to the present invention is explained.

The fourth and the fifth preferred embodiments are configured to comprise the table which stipulates a termination process on the control box 3 side. However, if the number of buttons grows, the size of this table increases. The sixth preferred embodiment takes this point into account. Namely, the computer 2 transmits an instruction to terminate this process beforehand as a reply to button pressing information, and the firmware of the control box 3 terminates the process based on this termination instruction upon detection that a button is released.

A process performed by the firmware of the control box 3 in the sixth preferred embodiment is explained below. Since also fundamental actions of the sixth preferred embodiment are basically the same as those of the third preferred embodiment shown in FIGS. 11 and 13 likewise the fourth and the fifth preferred embodiments, only a different portion is explained with reference to FIGS. 11 and 13.

In the sixth preferred embodiment, upon detection that a button is pressed in step S41 of FIG. 11, the firmware transmits button pressing information to the computer in step S43 in a similar manner as in the above described preferred embodiments. Upon receipt of the button pressing information in step S51 of FIG. 13, the computer 2 transmits a control command(s) for that button to the firmware in step S54. In the sixth preferred embodiment, also a termination process performed when this button is released is notified to the firmware at this time. When the button is detected to be released, or when a process continuance request cannot be received from the computer 2, the control box 3 side performs a termination process based on this instruction in step S48 of FIG. 11.

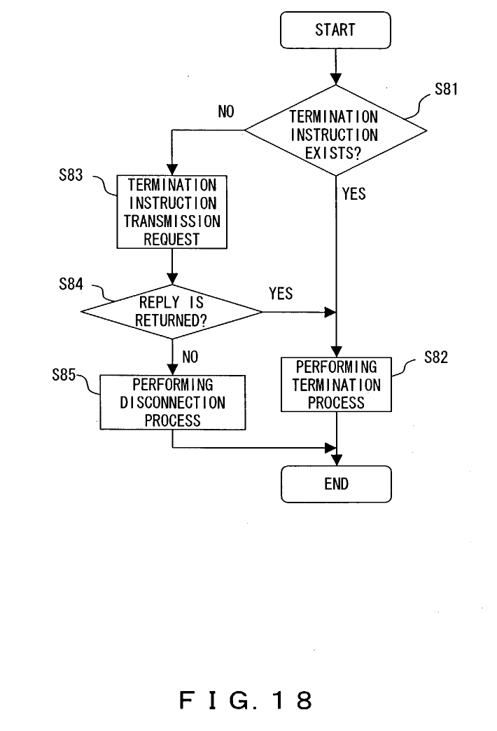

FIG. 18 is a flowchart showing a detailed process in step S48 of FIG. 11 in the sixth preferred embodiment.

In the process shown in this figure, upon detection of information (falling edge) indicating that a button is released, the firmware of the control box 3 first determines whether or not an instruction for a termination process exists in a process continuance request transmitted from the computer 2 side as step S81. If the instruction for the termination process exists in the process continuance request received in the past as a result of the determination (“Yes” in step S81), the firmware performs the termination process based on the instruction as step S82, and terminates the process.

If the instruction for the termination process is not received from the computer 2 in step S81 (“No” in step S81), the firmware requests the computer 2 to transmit a termination instruction as step S83. If a reply that instructs a termination process is returned from the computer 2 in correspondence with this request (“Yes” in step S84), the firmware performs the termination process according to that instruction (step S82), and terminates the process. Or, if the reply is not returned in step S84, the firmware performs a default disconnection process as the termination process as step S85, and terminates the process.

As descried above, in the sixth preferred embodiment, measures for a disconnection, and responsiveness for an action of releasing a button by a user can be implemented in a similar manner as in the fourth and the fifth preferred embodiments, and a table like that in the fourth and the fifth preferred embodiments is not required. Therefore, the sixth preferred embodiment can be implemented, for example, in the case where the size of the table increases due to a large number of buttons in the fourth and the fifth preferred embodiments, or in a configuration where memory space on the control box 3 side is tight.

The above explanation is provided by assuming a press button as an operation switch. However, the present invention is not limited to a press button, and applicable also to a configuration implemented by a switch such as a dial switch, a toggle switch, or the like.

Additionally, application of the present invention is not limited to a microscope device. The present invention is applicable to a device if it has a configuration where a device that can be operated by an operation unit, and a control unit that controls the entire device are isolated, and are connected via a communication.

According to the present invention, even if software is used for a communication between a control box and a computer, a process assigned to an operation button can be continued in the state where the operation button is being pressed, and terminated with the release of the button. Additionally, even if a computer runs away while a device is performing an action with pressing of a button, the action of the device can be aborted/stopped if the button is released.

Furthermore, an overhead of a communication with a computer side, etc., which occurs when a button is released, can be eliminated, whereby an action stop process can be immediately started. As a result, responsiveness for an operation by an end user can be enhanced.

What is claimed is:

1. An information input device having a computer and an external input device, and inputting information to a predetermined device, wherein:
the external input device comprises
one or more operation switches, and
a notifying unit discretely notifying the computer from when an operation switch becomes ON state until when the operation switch becomes OFF state; and
the computer comprises
a transmitting unit transmitting to the external input device a command to instruct the predetermined device of a process corresponding to the operation switch in correspondence with the notifying.

2. The information input device according to claim 1, wherein
the predetermined device is an electric microscope.

3. The information input device according to claim 2, wherein
the process corresponding to the operation switch issues to the electric microscope an instruction of an action for decreasing a distance between a sample on a stage of the electric microscope and an objective lens.

4. The information input device according to claim 1, wherein
the external input device is part of the predetermined device.

5. The information input device according to claim 1, wherein
the notifying unit discretely notifies the computer from when an edge of a signal from the operation switch is detected until when an edge is detected.

6. An information input device having a computer and an external input device, and inputting information to a predetermined device, wherein:
the external input device comprises
one or more operation switches,
a first notifying unit notifying the computer that an operation switch becomes ON state,
a first transmitting unit transmitting button pressing information to the computer upon receipt of an information transmission request from the computer when the operation switch is in the ON state, and
a second notifying unit notifying the computer that the operation switch becomes OFF state; and
the computer comprises
a second transmitting unit discretely transmitting the information transmission request to the external input device from when being notified that the operation switch becomes the ON state until when being notified that the operation switch becomes the OFF state, and
a third transmitting unit discretely transmitting a command to instruct the predetermined device of a process corresponding to the operation switch when the pressing information is notified from the external input device from when being notified that the operation switch becomes the ON state until when being notified that the operation switch becomes the OFF state.

7. The information input device according to claim 6, wherein
the predetermined device is an electric microscope.

8. The information input device according to claim 7, wherein
the process corresponding to the operation switch issues to the electric microscope an instruction of an action for decreasing a distance between a sample on a stage of the electric microscope and an objective lens.

9. The information input device according to claim 6, wherein
the external input device is part of the predetermined device.

10. The information input device according to claim 6, wherein:
the first notifying unit notifies the computer that the operation switch becomes the ON state upon detection of an edge of a signal from the operation switch; and
the second notifying unit notifies the computer that the operation switch becomes the OFF state upon detection of an edge of the signal from the operation switch after the first notifying unit notifies the computer.

11. An information input device having a computer and an external input device, and inputting information to a predetermined device, wherein:
the external input device comprises
one or more operation switches,
a notifying unit notifying the computer that an operation switch becomes ON state,
an aborting unit performing an abortion process for the predetermined device, if a process continuance request is not received from the computer for a predetermined time period when the operation switch is in the ON state, and
a termination processing unit notifying the computer that the operation switch becomes OFF state; and
the computer comprises
a process instructing unit transmitting to the external input device a command to instruct the predetermined device of a process corresponding to the operation switch, when being notified that the operation switch becomes the ON state, and
a process continuance request transmitting unit discretely transmitting the process continuance request to the external input device from when being notified that the operation switch becomes the ON state until when being notified that the operation switch becomes the OFF state.

12. The information input device according to claim 11, wherein:
the computer further comprises a termination process instructing unit instructing a termination process of the process corresponding to the operation switch when being notified that the operation switch becomes the OFF state; and
the termination processing unit performs the termination process of the process corresponding to the operation switch based on an instruction of the termination process from the computer.

13. The information input device according to claim 11, wherein:
the external input device further comprises a termination process storing unit storing a termination process of the process corresponding to the operation switch; and
the termination processing unit decides a termination process for the process corresponding to the operation switch by referencing the termination process storing unit, performs the termination process, and notifies the computer that the operation switch becomes the OFF state, when the operation switch becomes the OFF state.

14. The information input device according to claim 13, wherein:
the computer further comprises an additional process notifying unit notifying the external input device of an additional process if the additional process exists in the termination process of the process corresponding to the operation switch, when being notified that the operation switch becomes the OFF state; and
the termination processing unit performs the additional process in addition to the termination process in correspondence with the notifying of the additional process.

15. The information input device according to claim 11, wherein:
the computer further comprises a termination process notifying unit notifying the external input device of a termination process of the process corresponding to the operation switch when being notified that the operation switch becomes the ON state; and
the termination processing unit performs the termination process, and notifies the computer that the operation switch becomes the OFF state, when the operation switch becomes the OFF state.

16. The information input device according to claim 15, wherein
the termination process notifying unit adds the termination process to the process continuance request, and transmits the process continuance request to which the termination process is added.

17. An information input device having a computer and an external input device, and inputting information to a predetermined device, wherein:
the external input device comprises
one or more operation switches,
a notifying unit notifying the computer that an operation switch becomes ON state,
an aborting unit performing an abortion process for the predetermined device, if a process continuance request is not received from the computer for a predetermined time period when the operation switch is in the ON state,
a rewritable termination process storing unit storing a termination process of a process corresponding to the operation switch when the operation switch becomes OFF state,
a termination process rewriting unit rewriting the rewritable termination process storing unit based on a change instruction when the change instruction for the termination process is issued from the computer, and
a termination process deciding unit deciding a termination process to be performed by referencing the rewritable termination process storing unit, when the operation switch becomes the OFF state; and
the computer comprises
a process instructing unit notifying the external input device of a command to instruct the process corresponding to the operation switch, and an instruction of an additional process if the additional process exists in the termination process corresponding to the operation switch, when being notified that the operation switch becomes the ON state, and
a process continuance request transmitting unit discretely transmitting the process continuance request to the external input device from when being notified that the operation switch becomes the ON state until when being notified that the operation switch becomes the OFF state.

18. The information input device according to claim 17, wherein
the predetermined device is an electric microscope.

19. The information input device according to claim 18, wherein
the process corresponding to the operation switch issues to the electric microscope an instruction of an action for decreasing a distance between a sample on a stage of the electric microscope and an objective lens.

20. The information input device according to claim 17, wherein
the external input device is part of the predetermined device.

21. The information input device according to claim 17, wherein:
the notifying unit notifies the computer that the operation switch becomes the ON state upon detection of an edge of a signal from the operation switch; and
the termination process deciding unit decides a termination process to be performed upon detection of an edge of the signal from the operation switch after the notifying unit notifies the computer.

22. An information input device having a computer and an external input device, and inputting information to a predetermined device, wherein:
the external input device comprises
one or more operation switches,
notifying means for discretely notifying the computer from when an operation switch becomes ON state until when the operation switch becomes OFF state; and
the computer comprises
transmitting means for transmitting to the external input device a command to instruct the predetermined device of a process corresponding to the operation switch in correspondence with the notifying.

23. An information input device having a computer and an external input device, and inputting information to a predetermined device, wherein:
the external input device comprises
one or more operation switches,
first notifying means for notifying the computer that an operation switch becomes ON state,
first transmitting means for transmitting button pressing information to the computer upon receipt of an information transmission request from the computer, when the operation switch is in the ON state, and
second notifying means for notifying the computer that the operation switch becomes OFF state; and
the computer comprises
second transmitting means for discretely transmitting the information transmission request to the external input device from when being notified that the operation switch becomes the ON state until when the operation switch becomes the OFF state, and
third transmitting means for discretely transmitting a command to instruct the predetermined device of a process corresponding to the operation switch when the pressing information is notified from the external input device from when being notified that the operation switch becomes the ON state until when being notified that the operation switch becomes the OFF state.

24. An information input device having a computer and an external input device, and inputting information to a predetermined device, wherein:
the external input device comprises
one or more operation switches,
notifying means for notifying the computer that an operation switch becomes ON state,
aborting means for performing an abortion process for the predetermined device, if a process continuance request is not received from the computer for a predetermined time period when the operation switch is in the ON state, and
termination processing means for notifying the computer that the operation switch becomes OFF state; and
the computer comprises
process instructing means for transmitting to the external input device a command to instruct the predetermined device of a process corresponding to the operation switch, when being notified that the operation switch becomes the ON state, and
process continuance request transmitting means for discretely transmitting the process continuance request to the external input device from when being notified that the operation switch becomes the ON state until when being notified that the operation switch becomes the OFF state.

25. An information input device having a computer and an external input device, and inputting information to a predetermined device, wherein:
the external input device comprises
one or more operation switches,
notifying means for notifying the computer that an operation switch becomes ON state,
aborting means for performing an abortion process for the predetermined device, if a process continuance request is not received from the computer for a predetermined time period when the operation switch is in the ON state,
rewritable termination process storing means for storing a termination process of a process corresponding to the operation switch when the operation switch becomes OFF state,
termination process rewriting means for rewriting the rewritable termination process storing means based on a change instruction when the change instruction of the termination process is issued from the computer, and
termination process deciding means for deciding a termination process to be performed by referencing the rewritable termination process storing means, when the operation switch becomes the OFF state; and
the computer comprises
process instructing means for notifying the external input device of a command to instruct the process corresponding to the operation switch, and an instruction of an additional process if the additional process exists in the termination process corresponding to the operation switch, when being notified that the operation switch becomes the ON state, and
process continuance request transmitting means for discretely transmitting the process continuance request to the external input device from when being notified that the operation switch becomes the ON state until when being notified that the operation switch becomes the OFF state.
